(19) United States
(12) Patent Application Publication
(10) Pub. No.: US 2009/0102123 A1
(43) Pub. Date: Apr. 23, 2009

(54) Board Game and Method of Playing

(75) Inventor: Gordon Haas, Hoboken, NJ (US)

Correspondence Address: Leason Ellis LLP, 81 Main Street, Suite 503, White Plains, NY, 10601, US

(73) Assignee: Daydream Toy, Hoboken, NJ (US)

(21) Appl. No.: 12/239,768

(22) Filed: Sep. 27, 2008

Related U.S. Application Data
(60) Provisional application No. 60/980,703, filed on Oct. 17, 2007.

(51) Int. Cl. A63F 3/00; G09B 19/22

(52) U.S. Cl. 273/243; 434/128

(57) ABSTRACT

A method of playing a board game that assists a child to eat a healthy, balanced meal includes the steps of: (a) providing a set of food holders that hold a plurality of food items in separate locations; (b) identifying the individual food holders with different visual indicia; (c) providing a spinner device that includes a substrate with a surface that includes a plurality of playing spots that include visual indicia that corresponds to the food holders; (d) spinning a spinner that is above the substrate surface, the spinner having a first end that randomly points to one of the playing spots; (e) directing the player to consume food in one or more food holders in accordance with instructions that are present as part of the playing spot that is pointed to by the first end of the spinner; and (f) repeating the spinning and directing steps.

### CROSS-REFERENCE TO RELATED APPLICATION

The present application claims the benefit of U.S. patent application Ser. No. 60/980,703, filed Oct. 17, 2007, which is hereby incorporated by reference in its entirety.

### TECHNICAL FIELD

The present invention relates generally to a board game and in particular, relates to a board game that assists the player in learning to eat a balanced meal by linking the eating of different foods of the meal to game play and otherwise turning the entire eating experience into fun.

### BACKGROUND

The use of board games as a means of entertainment is well known in the prior art and despite the increased popularity of electronic video and computer games, board games remain a popular form of competitive amusement for both children and adults. Today's board games may be generally classified into several broad categories. Games such as chess and checkers are of a type that generally divide the game board into a series of squares, and game pieces are moved from square to square as dictated by the rules of the game without necessarily having to follow a particular pathway or route. There are also a wide variety of “pathway-type” board games wherein the game pieces are moved sequentially along a standardized play path, usually consisting of a sequence of blocks or spaces having at least a beginning space and an ending space, as in monopoly. Finally, there are board games which attempt to simulate or mimic a particular sport or activity, such as baseball and football. Countless variations and combinations of such types of board games are known in the prior art, many of which employ some form of chance-determining means, such as one or more die, a spinner having numerals thereon, or “chance” cards, for determining the movement of the game pieces.

In addition to amusing and entertaining the players, many board games also employ some type of teaching device, sequence, or materials in an attempt to add an educational aspect or means for increasing the knowledge or skill of the players concerning a particular subject or subjects to the game.

While there are a vast number of games that provide educational information in different fields, there is a need for providing an educational game that assists in teaching children that eating a nutritional meal can be a “fun” experience and that dinner time does not always have to be mundane, fussy time of the day as it is for many younger children.

### SUMMARY

A method of playing a board game that assists a child to eat a healthy, balanced meal includes the steps of: (a) providing a set of food holders that hold a plurality of food items in separate locations; (b) identifying the individual food holders with different visual indicia; (c) providing a spinner device that includes a substrate with a surface that includes a plurality of playing spots that include visual indicia that corresponds to the food holders; (d) spinning a spinner that is above the substrate surface, the spinner having a first end that randomly points to one of the playing spots; (e) directing the player to consume food in one or more food holders in accordance with instructions that are present as part of the playing spot that is pointed to by the first end of the spinner; and (f) repeating the spinning and directing steps.

A board game that assists and encourages a child to eat a healthy, balanced meal includes a food tray that includes a plurality of food holders that hold a plurality of food items in separate locations. The food holders are identified with different visual indicia that serve to uniquely identify each food holder. The board game further includes a spinner device that includes a substrate with a surface that includes a plurality of playing spots that include visual indicia that corresponds to the visual indicia that uniquely identifies the food holders. The spinner device has an arm that is rotatably coupled to the substrate and having a first end that randomly points to one of the playing spots after the arm comes to rest after being spun. Each playing spot has instructions displayed thereon that require the child to take one bite from food that is contained in at least one of the food holders.

### BRIEF DESCRIPTION OF THE DRAWING FIGURES

The foregoing and other features of the present invention will be more readily apparent from the following detailed description and drawings figures of illustrative embodiments of the invention in which:

FIG. 1 is a top plan view of a food holder that is part of a board game and a cup that is optionally part of the board game according to one exemplary embodiment of the present invention;

FIG. 2 is a top plan view of the food holder; and

FIG. 3 is a top plan view of a spinner that is part of the board game.

### DETAILED DESCRIPTION OF PREFERRED EMBODIMENTS

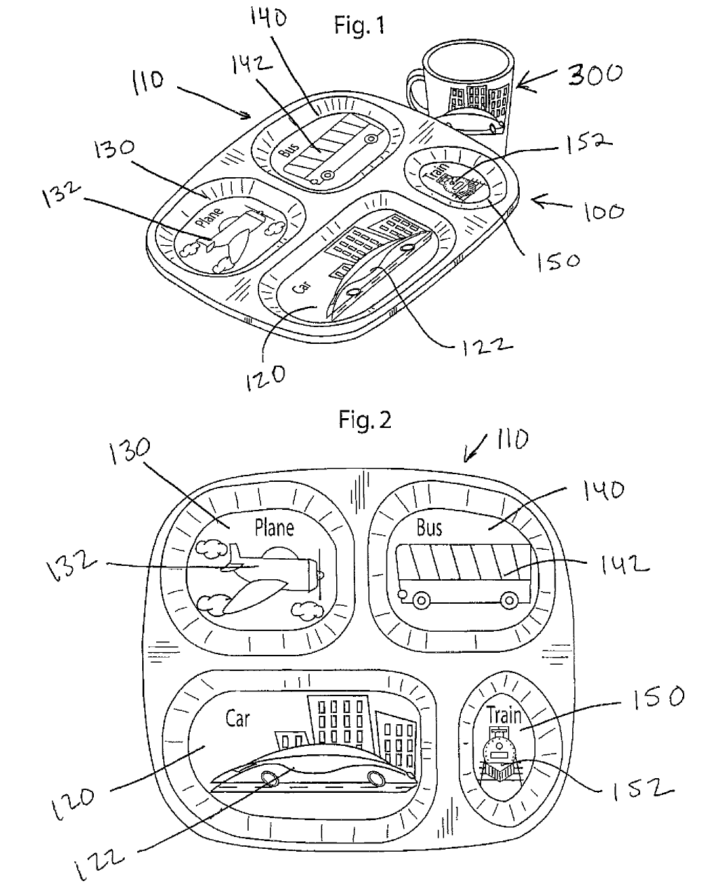

Referring to FIGS. 1-3, a board game 100 according to one exemplary embodiment is illustrated and is intended to assist children in eating their entire meals. It is common for children to not like to eat their entire meal in a timely manner. For example, some children take a relatively lengthy amount of time to finish their meal based on the meal containing one or more food items that the user is not particularly fond of eating. For example, many children do not like to eat vegetables and consequently, the child will slowly eat the vegetables thinking that after a while, the parent will become tired and will remove the meal from the child resulting in the child not having to eat the entire meal and more specifically, resulting in the child not having to eat healthy vegetables.

Other children do not like a particular food type, such as vegetables, and will refuse to eat this food type or will orally protest by crying or otherwise fussing or playing with the food when the parents request that the child eat the food type. This makes dinner time a difficult time for the parents and frankly, many parents do not look forward to dinner time and feeding their children.

The board game 100 is constructed to change how a child views the entire dinner experience and in particular, the board game 100 links the eating of a complete, balanced meal with the playing of the board game 100 and therefore makes the entire eating experience more enjoyable for the child.

The board game 100 includes a food holder member 110 which holds the meal to be eaten and in particular, is designed to segregate and hold the different food items that make up the meal. The illustrated food holder member 110 is in the form of a tray that has a number of recessed compartments for individually holding the different food items of the meal. For example, the food holder member 110 has a first recessed compartment 120 for holding a first food item or type, a second recessed compartment 130 for holding a second food item or type, a third recessed compartment 140 for holding a third food item or type, and a fourth recessed compartment 150 for holding a fourth food item or type. It will be appreciated that while the illustrated food holder type has four different recessed compartments, the food holder type is not limited to have four recessed compartments and instead can include less than four (e.g., two) or more than four (e.g., five) recessed compartments.

It is intended that the four recessed compartments 120, 130, 140, 150 hold the different food and prevent mixing or commingling of the food.

It will also be appreciated that the sizes of the four recessed compartments 120, 130, 140, 150 can be the same or more likely at least one of the recessed compartments will have a larger size than the others since one of the recessed compartments holds the main portion of the meal. For example, the first recessed compartment 120 can be designated as the compartment that holds the main meal component or food type and the other recessed compartments hold the side dishes, such as vegetables and fruit and dessert.

For example, a traditional child's meal will include a main food component (the first food item), vegetables (the second food item), fruit (the third food item), and a dessert (the fourth food item). Accordingly, in the illustrated embodiment, the main food component is contained in the first recessed compartment 120, vegetables are contained in the second recessed compartment 130, fruits are contained in the third recessed compartment 140 and the dessert is contained in the fourth recessed compartment 150.

The relative sizes of the recessed compartments can be selected in view of food that is intended to be placed in the respective recessed compartment. For example, the fourth recessed compartment 150 can be intended to hold the dessert of the meal and therefore, this compartment can have an area that is less than the other recessed compartments since it is not desirable for the child to eat too much dessert for any given meal. Since the consumption of vegetables and fruits is encouraged as being part of a healthy lifestyle and promotes healthy child growth. Thus, the second and third recessed compartments 130, 140 can be about the same size.

Some typical main food components include spaghetti, macaroni and cheese, chicken, pizza, hamburger, peanut butter and jelly sandwich, etc. Vegetables include the standard wide assortment of vegetables including green beans, carrots, broccoli, coin, etc. Fruits can include apples, bananas, strawberries, oranges, etc. Desserts can include cookies, brownie, ice cream, cake, etc.

In the illustrated embodiment, the depths of the recessed compartments 120, 130, 140, 150 can be the same or they can be different.

In accordance with the present invention, each of the recessed compartments includes an identifying indicia that identifies and distinguishes each of the recessed compartments from the other recessed compartments. For example, the first recessed compartment 120 includes first identifying indicia 122, the second recessed compartment 130 includes second identifying indicia 132, the third recessed compartment 140 includes third identifying indicia 142 and the fourth recessed compartment 150 includes fourth identifying indicia 152. The identifying indicia is different from one another since it serves to visually distinguish one compartment from another.

In contrast to having mundane indicia, such as different letters or different numerals, the identifying indicia 122, 132, 142, 152 is geared more to children and therefore has a children's theme. For example, the identifying indicia 122, 132, 142, 152 can have an animal theme, a transportation theme, a sports theme, a toy theme, etc.

FIGS. 1 and 2 illustrate identifying indicia 122, 132, 142, 152 that has an transportation theme. The identifying indicia 122, 132, 142, 152 can include not only graphic representations but also text. For example, when the indicia has a transportation theme, the first identifying indicia 122 has a graphic representation of an automobile and includes the text “Car”; the second identifying indicia 132 has a graphic representation of a plane and includes the text “Plane”, the third identifying indicia 142 has a graphic representation of a bus and includes the text “Bus”, and the fourth identifying indicia 152 has a graphic representation of a train and includes the text “Train”. When the identifying indicia takes the form of animals, the first identifying indicia 122 has a graphic representation of a cow and includes the text “Cow”; the second identifying indicia 132 has a graphic representation of a dog and includes the text “Dog”, the third identifying indicia 142 has a graphic representation of a horse and includes the text “Horse”, and the fourth identifying indicia 152 has a graphic representation of a cat and includes the text “Cat”.

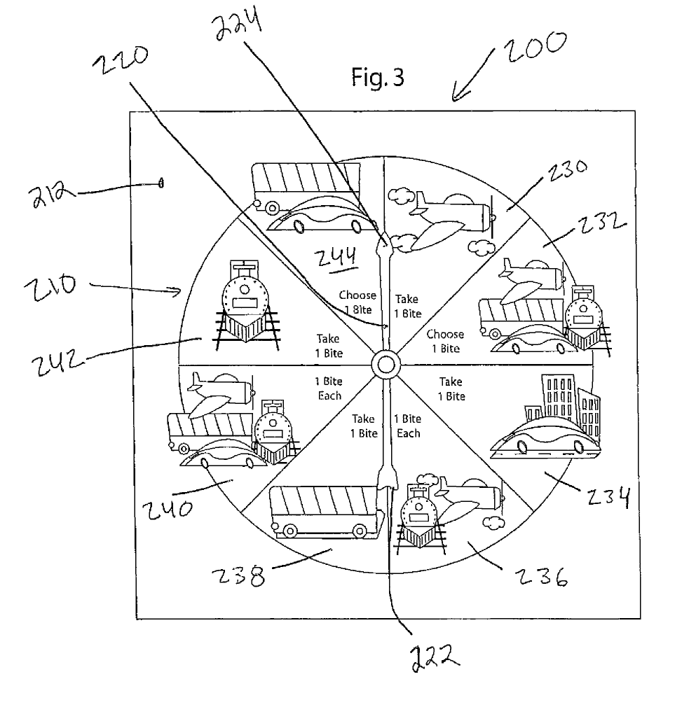

As shown in FIG. 3, the board game 100 includes a random number or space generator 200 that complements the food holder member 110 and provides instructions to the player. In one embodiment, the random number or space generator is in the form of a spinner wheel 200. The spinner 200 is of the type commonly found in board games being essentially circular with a finger-activated spinning arrow pivotally attached at the center. More specifically, the spinner wheel 200 has a substrate 210 that has a front face or surface 212 that faces the player as the game is played. The spinner wheel 200 also includes a finger-activated spinner or spinning arrow 220 that is rotatably coupled to the substrate 210 and includes a first end 222 that is the end which the player contacts to spin the spinner 220 and an opposite second pointed end 224 (arrow end) that provides instructions to the player.

The front face 212 includes a number of playing spaces that are arranged as pie-wedge segments of the circular playing surface of the spinner wheel 200. In accordance with the present invention, the arrow 224 is capable of landing on any of the pie-wedge segments specifying which food compartment is to be eaten from. In other words, when the player spins the spinner 220, the player is instructed or is given a choice as to where the next bite of the meal is to be taken from the food holder member 110. In one embodiment, there are eight (8) pie-wedge segments 230, 232, 234, 236, 238, 240, 242, 244 that contain indicia and/or text that instructs the player.

In the illustrated embodiment, the pie-wedge segment 230 has an illustration of the plane that is also formed on the second recessed compartment 130 and has the text “Take 1 Bite”, and therefore, if the user lands on this space during play, the player must take 1 Bite from the food item that is present in the second recessed compartment 130. The pie-wedge segment 232 has illustrations of the car, plane, bus and train that are also formed on the recessed compartment 120, 130, 140, 150, respectively, and has the text “Choose 1 Bite”, and therefore, if the user lands on this space during play, the player must take 1 Bite from any of the food items that are present in the recessed compartment 120, 130, 140, 150. This permits the child to take a bite from a favorite food that may be present. The pie-wedge segment 234 has an illustration of the car that is also formed on the first recessed compartment 120 and has the text “Take 1 Bite”, and therefore, if the user lands on this space during play, the player must take 1 Bite from the food item that is present in the first recessed compartment 120. The pie-wedge segment 236 has illustrations of the plane and train that are also formed on the second and fourth recessed compartment 130, 150 and has the text “1 Bite Each”, and therefore, if the user lands on this space during play, the player must take 1 Bite from the food items that are present in both the second and fourth recessed compartment 130, 150.

The pie-wedge segment 238 has an illustration of the bus that is also formed on the third recessed compartment 140 and has the text “Take 1 Bite”, and therefore, if the user lands on this space during play, the player must take 1 Bite from the food item that is present in the third recessed compartment 140. The pie-wedge segment 240 has illustrations of the car, plane, bus and train that are also formed on the recessed compartment 120, 130, 140, 150, respectively, and has the text “1 Bite Each”, and therefore, if the user lands on this space during play, the player must take 1 Bite from each of the food items that are present in the recessed compartment 120, 130, 140, 150. The pie-wedge segment 242 has an illustration of the train that is also formed on the fourth recessed compartment 150 and has the text “Take 1 Bite”, and therefore, if the user lands on this space during play, the player must take 1 Bite from the food item that is present in the fourth recessed compartment 150. The pie-wedge segment 244 has illustrations of the car and bus that are also formed on the first and third recessed compartments 120, 140 and has the text “Choose 1 Bite”, and therefore, if the user lands on this space during play, the player can choose to take 1 Bite from the food items that are present in the first and third recessed compartments 120, 140.

The child spins the spinner 220 and eats food from wherever the spinner 220 lands as a result of the pie-wedge segments providing eating instructions to the player. In this manner, eating is turned into child's play and once engaged in an entertaining meal, children won't notice that they are actually eating very healthy food.

Of course, the above eating instructions that are provided on the pie-wedge segments are merely exemplary and it will be understood that the pie-wedge segments can include other eating instructions other than the ones described above. In any event, the board game 100 is designed to enhance and encourage a child to eat a healthy, balanced meal.

The front face 212 of the substrate 210 of the spinner wheel 200 is preferably formed of a washable surface and includes some protective coating, like a plastic coating, so that in the event that food or drink is accidentally dropped on the spinner wheel 200, it can be easily removed by wiping it off.

Optionally and as shown in FIG. 1, the board game 100 includes a cup 300 that has the graphic representations that form a part of the board game 100. In other words, the cup has the graphic representations that are found in the recessed compartments and on the playing surface of the spinner wheel 200.

It will also be understood that the food holder can include different graphics than those represented herein and can otherwise be identified so long as there is a coordination between the playing spots on the spinner wheel and the compartments of the food holder. For example, the compartments of the food holder can be identified with different colors and the spinner wheel can have corresponding color blocks and instructions that dictate which food compartments are to be eaten from. In addition, the number of pie-segments can be varied and the instructions on the spinner wheel also can be varied and be different from the ones illustrated herein so long as the spinner wheel includes instructions that result in eating from each of the food compartments.

What is claimed is:

1. A method of playing a board game that assists and encourages a child to eat a healthy, balanced meal comprising the steps of:
providing a set of food holders that hold a plurality of food items in separate locations;
identifying the food holders with different visual indicia;
providing a spinner device that includes a substrate with a surface that includes a plurality of playing spots that include visual indicia that corresponds to the food holders;
spinning a spinner that is above the substrate surface, the spinner having a first end that randomly points to one of the playing spots;
directing the player to consume food in one or more food holders in accordance with instructions that are present as part of the playing spot that is pointed to by the first end of the spinner; and
repeating the spinning and directing steps.

2. The method of claim 1, wherein the set of food holders comprises a tray that includes recessed compartments that correspond to the set of food holders, each recessed compartment holding a different food item.

3. The method of claim 1, wherein the different visual indicia includes different graphic representations that have a common theme and optionally includes text that relates to the graphic representations.

4. The method of claim 3, wherein the theme is animals and the visual indicia includes graphic representations of different animals.

5. The method of claim 3, wherein the theme is transportation and the visual indicia includes graphic representations of different means of transporting individuals.

6. The method of claim 5, wherein the graphic representations include a picture of a car, a picture of a plane, a picture of a bus, and a picture of a train.

7. The method of claim 2, wherein at least two of the recessed compartments have different sizes.

8. The method of claim 2, wherein a first recessed compartment holds a main entrée, a second recessed compartment hold vegetables, a third recessed compartment hold fruits, and a fourth recessed compartment hold a dessert.

9. The method of claim 1, wherein the plurality of playing spots comprise pie-wedge segments.

10. The method of claim 9, wherein the instructions of each playing spot includes at least one of the visual indicia that correspond to one of the food holders and includes text that provides directions as to which food to consume.

11. The method of claim 10, wherein one playing spot includes two or more visual indicia that correspond to two or more food holders.

12. The method of claim 10, wherein the text is directs the player to “take 1 bite” from the food holder indicated on the playing spot or to “choose 1 bite” from one of the food holders indicated on the playing spot.

13. The method of claim 10, wherein at least one playing spot includes the text “1 bite each” from two food holders that are visually depicted on the playing spot by the visual indicia.

14. A board game that assists and encourages a child to eat a healthy, balanced meal comprising:
a food tray that includes a plurality of food holders that hold a plurality of food items in separate locations, the food holders being identified with different visual indicia that serve to uniquely identify each food holder; and
a spinner device that includes a substrate with a surface that includes a plurality of playing spots that include visual indicia that corresponds to the visual indicia that uniquely identifies the food holders, the spinner device having an arm that is rotatably coupled to the substrate and having a first end that randomly points to one of the playing spots after the arm comes to rest after being spun, each playing spot having instructions displayed thereon that require the child to take one bite from food that is contained in at least one of the food holders.

15. The board game of claim 14, wherein the tray that includes recessed compartments that correspond to the set of food holders, each recessed compartment holding a different food item.

16. The board game of claim 14, wherein the different visual indicia includes different graphic representations that have a common theme and optionally includes text that relates to the graphic representations.

17. The board game of claim 16, wherein the theme is animals and the visual indicia includes graphic representations of different animals.

18. The board game of claim 16, wherein the theme is transportation and the visual indicia includes graphic representations of different means of transporting individuals.

19. The board game of claim 15, wherein at least two of the recessed compartments have different sizes.
